(19) United States
(12) Patent Application Publication
(10) Pub. No.: US 2013/0229750 A1
(43) Pub. Date: Sep. 5, 2013

(54) SOLID ELECTROLYTIC CAPACITOR AND METHOD FOR PRODUCING THE SAME, AND ELECTROCONDUCTIVE POLYMER COMPOSITION

(71) Applicant: NEC TOKIN CORPORATION, Sendai-shi (JP)

(72) Inventors: Tomoki NOBUTA, Sendai-shi (JP); Yasuhisa SUGAWARA, Sendai-shi (JP); Satoshi SUZUKI, Sendai-shi (JP); Yasuhiro TOMIOKA, Sendai-shi (JP)

(73) Assignee: NEC TOKIN Corporation, Sendai-shi (JP)

(21) Appl. No.: 13/772,054

(22) Filed: Feb. 20, 2013

(30) Foreign Application Priority Data
Feb. 21, 2012 (JP) 2012-034610

(51) Int. Cl. H01G 9/025; H01G 9/15

(52) U.S. Cl. CPC H01G 9/025; H01G 9/15
USPC 361/525; 252/62.2; 427/80

(57) ABSTRACT

The present invention provides an electroconductive polymer composition for a solid electrolytic capacitor which has a high electroconductivity and an excellent heat resistance. Also, the present invention provides a solid electrolytic capacitor having a low ESR and an excellent heat resistance.

The present invention is an electroconductive polymer composition, obtained by removing a solvent or a dispersing medium from an electroconductive polymer solution comprising: an electroconductive polymer in which a dopant is doped; an oxazoline group-containing compound; a water-soluble compound having at least one or more of carboxyl group, aromatic phenol group and thiol group as a functional group; and a solvent or a dispersing medium.

This application is based upon and claims the benefit of priority from Japanese patent application No. 2012-34610, filed on Feb. 21, 2012, the disclosure of which is incorporated herein in its entirety by reference.

### BACKGROUND OF THE INVENTION

1. Field of the Invention

The present invention relates to a solid electrolytic capacitor and a method for producing the same, and to an electroconductive polymer composition. For details, the present invention relates to a solid electrolytic capacitor having an excellent heat resistance property and an electroconductive polymer composition having a high strength and an excellent heat resistance in which the deterioration of the electroconductivity by a heat stress is suppressed.

2. Description of the Related Art

Solid electrolytic capacitors, which are obtained by forming a dielectric oxide film on a porous body of a valve metal such as tantalum or aluminum by anodic oxidation method and thereafter by forming an electroconductive polymer on this oxide film to be a solid electrolyte, are developed.

These solid electrolytic capacitors have an equivalent series resistance (hereinafter, referred to as ESR) lower than that of a capacitor in which the solid electrolyte is manganese dioxide conventionally used, and they are used for various purposes. Recently, solid electrolytic capacitors having a low ESR, a large capacity, and a small loss are required with a trend of high frequency and high current of an integrated circuit.

The methods for forming an electroconductive polymer layer that comes to be a solid electrolyte of this solid electrolytic capacitor are roughly classified into chemical oxidative polymerization and electrolytic oxidative polymerization. As the monomer constituting an electroconductive polymer material, pyrrole, thiophene, 3,4-ethylenedioxythiophene, aniline and the like are known. Also, recently, there is a method in which an electroconductive polymer solution is applied to form a solid electrolyte.

The electroconductive polymer solution is generally provided as a dispersion or a solution in an aqueous solvent or as a solution in an organic solvent, and the solvent is removed at the time of use to be used as an electroconductive polymer material. It is variously studied as antistatic materials, electromagnetic shield materials, electrodes of capacitors, electrochemical capacitors and the like, electrodes of dye-sensitization solar cells, organic thin film solar cells and the like, and electrodes of electroluminescence displays. Recently, in order to provide an electroconductive polymer material having a higher performance, the developments regarding a method for producing an electroconductive polymer solution and regarding a composition, for example, in which an additive is added to provide a new function, is actively carried out.

As a technology regarding the electroconductive polymer solution, technologies regarding a cross-linker are disclosed as follows.

JP 2007-31712 A discloses a technology regarding an antistatic polyester film which has an improved adhesion to a substrate, water resistance, repellency, solvent resistance, antistatic property and transparency by applying a coating liquid containing an electroconductive polymer resin, a binder resin, cross-linker (C) and fluorine silica dispersion compound (D) to at least one side of a polyester film. As the cross-linker, one or more kind selected from the group consisting of isocyanates, carbonyl imides, oxazolines and melamine compounds is used.

JP 2010-77294 A relates to an antistatic coating composition for a substrate film, in which a film can be formed only by drying and which has an excellent transparency, abrasion resistance, water resistance, solvent resistance and electroconductivity, and discloses a technology regarding an antistatic coating composition which contains an electroconductive polymer containing a particular polycationic polythiophene and a polyanion, a binder resin, cross-linker (C), polyvinyl alcohol resin (D), compound (E) having an amide group or a hydroxyl group in a molecule, and monovalent alcohol (F) with a carbon number of 1 to 4, wherein the binder resin contains a functional group and wherein cross-linker (C) has a functional group which can be reacted with the functional group of the binder resin. Cross-linker (C) contains at least one or more functional group selected from the group consisting of aziridine group, carbodiimide group, oxazoline group and epoxy group.

However, these technologies relate to an electroconductive polymer solution for obtaining an antistatic electroconductive polymer compound. In order to satisfy various performances required for the purposes, it contains various compounds which make the electroconductivity reduced.

As the purpose for electrolytes of solid electrolytic capacitors, for example, in order to satisfy a requirement for low ESR, it is important to reduce the resistance of the electrolyte, namely to make the composition have a high electroconductivity. Also, in order to satisfy a requirement for a capacitor having a high heat resistance, it is necessary to maintain the electroconductivity against a heat stress or the like, and to improve the strength of the electrolyte against the heat as one mean. Thus, since further higher electroconductivity is required than the antistatic purpose, the technologies are not always sufficient in the standpoint of the electroconductivity of the electroconductive compound.

That is, the problem of the present invention is to provide an electroconductive composition for a solid electrolytic capacitor which has a high electroconductivity and an excellent heat resistance and also to provide a solid electrolytic capacitor having a low ESR and an excellent heat resistance.

### SUMMARY OF THE INVENTION

In order to solve the above-mentioned problem, the electroconductive polymer solution according to the present invention contains an electroconductive polymer in which a dopant is doped, an oxazoline group-containing compound, a water-soluble compound having at least one of carboxyl group, aromatic phenol group and thiol group as a functional group, and a solvent or a dispersing medium. Here, it preferably contains the oxazoline group-containing compound and the water-soluble compound in a range of 1.0:0.2 to 1.3 in a mol ratio of the corresponding functional group.

Also, the electroconductive polymer according to the present invention includes at least one kind selected from the group consisting of polypyrroles, polythiophenes and polyanilines, and derivatives thereof. Further, the electroconductive polymer preferably has a repeating unit of 3,4-ethylenedioxythiophene or a derivative thereof.

Also, the electroconductive polymer composition according to the present invention is obtained by removing the solvent or the dispersing medium from the above-mentioned electroconductive polymer solution, and contains an amide ester unit formed from the electroconductive polymer, the oxazoline group-containing compound and the water-soluble compound. The removal of the solvent or the dispersing medium is preferably carried out by heating the above-mentioned electroconductive polymer solution at 80° C. or higher and 300° C. or lower.

Also, in the electroconductive polymer composition according to the present invention, an amide ester unit is formed from an oxazoline group-containing compound and a water-soluble compound having at least one of carboxyl group, aromatic phenol group and thiol group as a functional group, and the unit is laid in an electroconductive polymer matrix or between electroconductive polymer dispersing particles.

Also, the solid electrolytic capacitor according to the present invention includes a solid electrolyte which contains the electroconductive polymer composition according to the present invention.

The method for producing a solid electrolytic capacitor by the present invention, includes: forming a dielectric layer on a surface of an anode conductor containing a valve metal; carrying out an application or an impregnation of the electroconductive polymer solution described in any one of the above on the dielectric layer; and removing the solvent or the dispersing medium from the electroconductive polymer solution to form a solid electrolyte layer containing the electroconductive polymer composition.

Further, the method for producing a solid electrolytic capacitor by the present invention, includes: forming a dielectric layer on a surface of an anode conductor containing a valve metal; carrying out an oxidative polymerization of a monomer providing an electroconductive polymer on the dielectric layer to form a first solid electrolyte layer containing the electroconductive polymer; carrying out an application or an impregnation of the electroconductive polymer solution described in any one of the above on the first solid electrolyte layer; and removing the solvent or the dispersing medium from the electroconductive polymer solution to form a second solid electrolyte layer.

According to the present invention, an electroconductive polymer composition having a high strength and a high electroconductivity is provided. Also, a solid electrolytic capacitor having a low ESR and an excellent heat resistance is provided.

### BRIEF DESCRIPTION OF THE DRAWING

FIG. 1 is a schematic view showing a section of the solid electrolytic capacitor according to an embodiment of the present invention.

### DETAILED DESCRIPTION OF THE PREFERRED EMBODIMENTS

### (Electroconductive Polymer Solution)

The electroconductive polymer solution according to the present invention contains an electroconductive polymer in which a dopant is doped; an oxazoline group-containing compound; a water-soluble compound having at least one or more of carboxyl group, aromatic phenol group and thiol group as a functional group; and a solvent or a dispersing medium. The electroconductive polymer according to the present invention means an electroconductive polymer in which a dopant is doped to develop an electroconductivity.

As a dopant, it is possible to use not only an inorganic acid but also an organic acid with a low molecular weight or an organic acid with a high molecular weight, a salt thereof, or the like.

As the inorganic acid, it is possible to use, for example, a proton acid such as sulfuric acid, nitric acid, phosphoric acid, perchloric acid, tetrafluoroboric acid, or hexafluorophosphoric acid, or the like. This may be used alone, or in combination with two or more kinds.

The organic acid with a low molecular weight may be a monosulfonic acid, a disulfonic acid or a trisulfonic acid, and examples thereof include, for example, alkyl sulfonic acids, benzenesulfonic acid, naphthalenesulfonic acid, anthraquinone sulfonic acid, camphor sulfonic acid and derivatives thereof.

Examples of the derivative of the alkyl sulfonic acid include, for example, 2-acrylamide-2-methylpropanesulfonic acid and dodecylbenzenesulfonic acid.

Examples of the derivative of benzenesulfonic acid include, for example, phenolsulfonic acid, styrenesulfonic acid, toluenesulfonic acid and sulfophthalic acid.

Examples of the derivative of naphthalenesulfonic acid include, for example, 1-naphthalenesulfonic acid, 2-naphthalenesulfonic acid, 1,3-naphthalenedisulfonic acid, 1,3,6-naphthalenetrisulfonic acid and 6-ethyl-1-naphthalenesulfonic acid.

Examples of the derivative of anthraquinone sulfonic acid include, for example, anthraquinone-1-sulfonic acid, anthraquinone-2-sulfonic acid, anthraquinone-2,6-disulfonic acid and 2-methylanthraquinone-6-sulfonic acid.

Examples of the derivative of camphor sulfonic acid include, for example, (+)-10-camphor sulfonic acid and (+)-10-camphor sulfonic acid. Also, it may be an optically active substance.

Examples of the salt of the organic acid with a low molecular weight include iron (III) salts of them.

Among these, benzenesulfonic acid or naphthalenesulfonic acid is preferable. This may be used alone, or in combination with two or more kinds.

Examples of the organic acid with a high molecular weight include, for example, substituted or non-substituted polyacrylic resins such as poly(2-acrylamide-2-methylpropanesulfonic acid)s, substituted or non-substituted polyvinyl resins such as polyvinyl sulfonic acids, substituted or non-substituted polystyrene resins such as polystyrene sulfonic acids, substituted or non-substituted polyester resins such as polyester sulfonic acids, and copolymers containing one or more kind selected from these.

Examples of the salt of the organic acid with a high molecular weight include, for example, lithium salts, sodium salts, potassium salts and ammonium salts of the organic acid with a high molecular weight. Among these, a polystyrene sulfonic acid or a polyester sulfonic acid is preferable. This may be used alone, or in combination with two or more kinds.

As the electroconductive polymer, a π-conjugated electroconductive polymer can be used. Examples of the π-conjugated electroconductive polymer include polypyrroles, polythiophenes, polyanilines, polyacetylenes, poly(p-phenylene)s, poly(p-phenylene vinylene)s and poly(thienylene vinylene)s and derivatives thereof, which are substituted or non-substituted.

Examples of the substituent include not only hydrogen atom, hydroxyl group, carboxyl group, nitro group, phenyl group, vinyl group, halogen atoms, acyl group, amino group, sulfonic acid group, sulfonyl group, carboxylic acid ester group, sulfonic acid ester group, alkoxyl groups, alkylthio groups or arylthio groups, but also alkyl groups with C1 to C18 which may have a substituent thereof, cycloalkyl groups with C5 to C12 which may have a substituent thereof, aryl groups with C6 to C14 which may have a substituent thereof, or aralkyl groups with C7 to C18 which may have a substituent thereof.

Among these, the electroconductive polymer is preferably an electroconductive polymer which contains at least one kind selected from the group consisting of polypyrroles, polythiophenes and polyanilines, and derivatives thereof, and more preferably contains a repeating unit of 3,4-ethylenedioxythiophene or a derivative thereof from the viewpoint of the heat stability. The electroconductive polymer may be a homopolymer or a copolymer. Also, this electroconductive polymer may be used alone, or in combination with two or more kinds.

As the solvent or the dispersing medium, it is preferable to select a solvent or a dispersing medium which has a good compatibility with the electroconductive polymer, and it may be water or a water-mixed organic solvent. Specific examples of the organic solvent include not only polar solvents such as N-methyl-2-pyrrolidone, N,N-dimethylformamide, N,N-dimethylacetamide, dimethylsulfoxide and formamide, but also alcohol solvents such as methanol, ethanol and propanol, aromatic hydrocarbon solvents such as benzene, toluene and xylene, or aliphatic hydrocarbon solvents such as hexane. The organic solvent can be used alone, or in combination with two or more kinds. Among these, water or a combination of water and a polar solvent is preferable.

The content of the electroconductive polymer contained in the electroconductive polymer solution is preferably 0.1 part by mass or more and 30.0 parts by mass or less with respect to 100 parts by mass of the solvent, and is more preferably 0.5 part by mass or more and 20.0 parts by mass or less.

The method for synthesizing the electroconductive polymer according to the present invention is not particularly limited. For example, it can be synthesized by carrying out a chemical oxidative polymerization or an electropolymerization of a monomer providing an electroconductive polymer in a solution containing a dopant using an oxidant. The electroconductive polymer obtained may contain a component such as an unreacted monomer or a residual component derived from the oxidant, which is unnecessary for developing the electroconductivity. In this case, it is preferable to remove the component by an extraction by ultrafiltration, centrifuge separation, or the like, by an ion-exchange treatment, or by a dialysis treatment. The qualitative and quantitative analysis of the unnecessary component contained in the electroconductive polymer can be carried out by inductively coupled high-frequency plasma (ICP) emission spectrometer, ion chromatography, UV absorption or the like.

The electroconductive polymer solution according to the present invention contains not only an electroconductive polymer and a solvent or a dispersing medium, but also an oxazoline group-containing compound and a water-soluble compound having at least one or more of carboxyl group, aromatic phenol group and thiol group as a functional group. From the electroconductive polymer solution containing these oxazoline group-containing compound and water-soluble compound, an electroconductive polymer composition is obtained having a high strength of the film and an excellent heat resistance. Note that, these oxazoline group-containing compound and water-soluble compound do not function as a dopant of the electroconductive polymer.

Also, these oxazoline group-containing compound and water-soluble compound is preferably water-soluble. “Water-soluble” means a character that it can be dissolved or uniformly dispersed in water.

As the oxazoline group-containing compound, it is suitable to use, for example, EPOCROS (registered trademark) (produced by NIPPON SHOKUBAI CO., LTD.). Specific examples thereof include K-2010E, K-2020E, K-2030E, WS-300, WS-500 and WS-700. It may be used alone, or in combination with two or more kinds.

As the water-soluble compound, it is possible to use water-soluble compounds having at least one or more of carboxyl group, aromatic phenol group and thiol group as a functional group. Examples thereof include, for example, aliphatic or aromatic compounds with a low molecular weight and derivatives thereof such as oxalic acid, malonic acid, succinic acid, fumaric acid, malic acid, adipic acid, citric acid, phthalic acid, phenol and monovalent to tetravalent phenol derivatives, and thiophenol and derivatives thereof; and polymers such as polyacrylic acids, polymethacrylic acids, polymaleic acids, and polyethylenes, polyesters, polyimides, polyamides, fluorine resins, polyvinyls, polystyrenes, polyurethanes, polyureas, phenol resins, polyethers and polyacryls which are water-soluble modified and which have at least one or more of carboxyl group, aromatic phenol group and thiol group as a functional group, and copolymers thereof. This may be used alone, or in combination with two or more kinds. Among these, phthalic acid, a polyacryl or a water-soluble modified polyester is preferable.

Examples of the functional group introduced for water-soluble modification include hydrophilic groups such as hydroxyl group, sulfonic acid group and carboxyl group. As the resin, it is suitable to use PESRESIN A series (produced by TAKAMATSU OIL & FAT Co., Ltd.) which contain a polyester resin or an acryl-modified polyester resin and which are an aqueous resin having a carboxyl group or a sulfonic acid group as a hydrophilic group.

The weight average molecular weight of the polymer is not particularly limited, but is preferably 2000 to 700000, is more preferably 5000 to 500000, and is further preferably 10000 to 200000. The weight average molecular weight can be measured by GPC (gel permeation chromatograph).

Since the oxazoline group-containing compound and the water-soluble compound have a high solubility to the electroconductive polymer solution and do not damage the dispersion state of the electroconductive polymer, the time-related stability of the electroconductive polymer solution is excellent.

The total amount of the oxazoline group-containing compound and the water-soluble compound which are contained in the electroconductive polymer solution can be set in a range in which the electroconductivity of the electroconductive polymer is not deteriorated. The ratio of the electroconductive polymer and (the oxazoline group-containing compound+the water-soluble compound) is preferably 1.0:0.1 to 2.0 and is more preferably 1.0:0.1 to 1.5 in a mass ratio.

As a method for producing an electroconductive polymer solution, an oxazoline group-containing compound and a water-soluble compound are mixed and dissolved in a solution obtained by the above-mentioned method for synthesizing an electroconductive polymer for the production. The order of mixing is not particularly limited. Also, the solution before mixing the oxazoline group-containing compound and the water-soluble compound is preferably a solution obtained by removing a remaining component derived from the oxidant used when the electroconductive polymer is synthesized.

### (Electroconductive Polymer Composition)

The electroconductive polymer composition of the present invention is obtained by removing the solvent or the dispersing medium from the above-mentioned electroconductive polymer solution. By the process of removing the solvent or the dispersing medium, an amide ester unit is generated from the oxazoline group-containing compound and the water-soluble compound. This unit is laid in the electroconductive polymer matrix (or between the electroconductive polymer dispersing particles in the case in which the electroconductive polymer is in the form of the dispersed particle), and thereby the strength of the electroconductive polymer composition is improved and the heat resistance is improved. For details, to lay these units results in improving the binding property between the electroconductive polymers and suppressing the deterioration of the electroconductivity by the outside stress such as a heat.

The evaluation of the heat resistance is carried out, for example, by a method in which the changing of the resistance ratio by leaving the electroconductive polymer composition under a high temperature environment is confirmed, or by differential thermogravimetric analysis (TG/DTA). The change of the organic structure can be confirmed by Fourier transform infrared spectrometry (FTIR) or the like.

The method for removing the solvent or the dispersing medium is not particularly limited, but is preferably a method by heating it at 80° C. or higher in order to react the oxazoline group-containing compound and the water-soluble compound, and the temperature is preferably 100° C., that is a boiling point of water, or higher. The upper limit is not particularly limited as long as it is a temperature which is equal to or lower than the decomposition temperature of the electroconductive polymer, but it is preferably 300° C. or lower. The drying time must appropriately be optimized by the drying temperature, but is not particularly limited as long as the electroconductive polymer is not deteriorated by the heat.

As for the mixed ratio of the oxazoline group-containing compound and the water-soluble compound which are contained in the electroconductive polymer solution, in order to carry out a sufficient reaction, the mol ratio of the functional group of the oxazoline group-containing compound and the functional group of the water-soluble compound is preferably 1.0:0.2 to 1.3 and is more preferably 1.0:0.5 to 1.2. By setting it in this range, an unreacted compound is reduced as much as possible, and the strength and the heat resistance of the electroconductive polymer composition can sufficiently be improved.

### (Solid Electrolytic Capacitor)

The solid electrolytic capacitor according to the present invention has a solid electrolyte which contains the electroconductive polymer composition according to the present invention. By containing the electroconductive polymer composition according to the present invention as a solid electrolyte, a solid electrolytic capacitor having a low ESR and an excellent heat resistance is obtained.

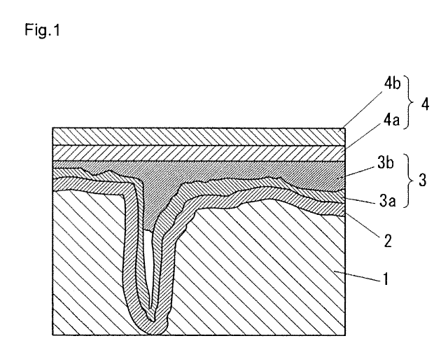

FIG. 1 is a schematic view showing a section of the solid electrolytic capacitor according to an embodiment of the present invention. The solid electrolytic capacitor has a conformation in which dielectric layer 2, solid electrolyte layer 3 and cathode conductor 4 were laminated in this order on anode conductor 1.

Anode conductor 1 is formed of: a plate, a foil or a wire of a valve metal; a sintered body containing a fine particle of a valve metal; a porous metal subjected to a surface area enlargement treatment by etching; or the like. Specific examples of the valve metal include tantalum, aluminum, titanium, niobium, zirconium, and alloys thereof. Among these, at least one kind selected from the group consisting of aluminum, tantalum and niobium is preferable.

Dielectric layer 2 is a layer which can be formed by an electrolytic oxidation of the surface of anode conductor 1, and is also formed in the pores of a sintered body or a porous body. The thickness of dielectric layer 2 can be appropriately adjusted by the voltage of the electrolytic oxidation.

Solid electrolyte layer 3 contains an electroconductive polymer composition obtained by removing the solvent or the dispersing medium from at least the electroconductive polymer solution according to the present invention. Examples of the method for forming solid electrolyte layer 3 include, for example, a method in which an application or an impregnation of the electroconductive polymer solution according to the present invention on dielectric layer 2 is carried out and in which the solvent or the dispersing medium of the electroconductive polymer solution is removed. The method for the application or the impregnation is not particularly limited. In order to sufficiently fill the electroconductive polymer composition into the porous pore inside, it is preferably left for several minutes to several ten minutes after the application or the impregnation. Further, the immersion is preferably repeated, and is preferably carried out by the reduced system or the pressurized system.

The solvent or the dispersing medium of the electroconductive polymer solution can be removed by drying the electroconductive polymer solution. The method for drying it is not particularly limited. The drying temperature for removing the solvent is preferably 80° C. or higher, and is more preferably 100° C., that is a boiling point of water, or higher. The upper limit of the drying temperature is not particularly limited as long as it is a temperature which is equal to or lower than the decomposition temperature of the electroconductive polymer, but it is preferably 300° C. or lower from the viewpoint of preventing the deterioration of the element by heating. Also, it is preferably determined in consideration of the heat resistance of the other materials. The drying time must appropriately be optimized by the drying temperature, but is not particularly limited as long as the electroconductivity is not deteriorated.

Further, solid electrolyte layer 3 may contain an electroconductive polymer including pyrrole, thiophene, aniline or a derivative thereof; an oxide derivative such as manganese dioxide or ruthenium oxide, or an organic semiconductor such as TCNQ (7,7,8,8-tetracyanoquinodimethane complex salt). As shown in FIG. 1, solid electrolyte layer 3 can have a two-layer structure of first solid electrolyte layer 3a and second solid electrolyte layer 3b. For example, a chemical oxidation polymerization or an electropolymerization of a monomer providing an electroconductive polymer is carried out to form first solid electrolyte layer 3a containing the electroconductive polymer on dielectric layer 2. An application or an impregnation of the electroconductive polymer composition according to the present invention is carried out on first solid electrolyte layer 3a, and the solvent is removed to form second solid electrolyte layer 3b.

As a monomer, at least one kind selected from the group consisting of pyrrole, thiophene, aniline and derivatives thereof can be used. As a dopant used for chemical oxidative polymerization or electropolymerization of the monomer to obtain an electroconductive polymer, sulfonic acid compounds such as alkyl sulfonic acids, benzenesulfonic acid, naphthalenesulfonic acid, anthraquinone sulfonic acid, camphor sulfonic acid and derivatives thereof are preferable. This may be used alone, or in combination with two or more kinds. The molecular weight of the dopant can appropriately be selected from low molecular weight compounds and high molecular weight compounds.

The solvent may be water only or may also be a mixed solvent of water and a water-soluble organic solvent.

It is preferable that the electroconductive polymer contained in first solid electrolyte layer 3a is a polymer which has the same skeleton as that of the electroconductive polymer contained in second solid electrolyte layer 3b. Cathode conductor 4 is not particularly limited as long as it is a conductor. For example, it can be designed to have a two-layer structure having carbon layer 4a such as graphite and silver electroconductive resin layer 4b.

### EXAMPLES

As follows, the present invention is further specifically explained based on the Examples, but the present invention is not limited to these examples and includes the embodiments based on the idea of the present invention, too.

### Example 1

A porous aluminum foil of 3×4 mm which was subjected to a surface area enlargement treatment by etching was used as an anode conductor. The immersion to a tank having a monomer solution, a dopant and an oxidant solution was repeated several times, and an electroconductive polymer layer containing a poly-3,4-ethylenedioxythiophene was formed on the porous body pore inside by chemical polymerization method, to be first solid electrolyte layer 3a.

Then, 1.1 g of 3,4-ethylenedioxythiophene was served into a mixture solution of 100 g of pure water and 5.9 g of 20 wt % polystyrene sulfonic acid (weight average molecular weight: 5×10⁴), and a stirring was carried out at normal temperature for 5 minutes. After that, 5 g of 40 wt % ammonium persulfate aqueous solution was served at 1 ml/min, and an oxidation polymerization was carried out with a further stirring (1000 rpm) at normal temperature for 50 hours to obtain an electroconductive polymer solution in which the content of an electroconductive polymer component containing a poly-3,4-ethylenedioxythiophene and a polystyrene sulfonic acid was about 2.2 wt %. At this time, the solution color was changed from pale yellow to dark navy blue.

Then, an amphoteric ion-exchange resin (product name: MB-1, ion-exchange type: —H and —OH, produced by ORGANO CORPORATION) was served to this solution, and a stirring was carried out for 30 minutes to remove an unnecessary component derived from the oxidant. The electroconductive polymer solution obtained was dark navy blue. 20 g of this electroconductive polymer solution was collected, and 0.86 g of formamide as a polar solvent was mixed. After that, 0.40 g of EPOCROS (registered trademark) WS-700 (25 wt % aqueous solution, produced by NIPPON SHOKUBAI CO., LTD.) as an oxazoline group-containing compound and 0.13 g of phthalic acid as a water-soluble compound were mixed, and a stirring was carried out for 60 minutes to obtain a dark navy blue electroconductive polymer solution.

5 μl of this electroconductive polymer solution was dropped on first solid electrolyte layer 3a and was preliminarily dried at 120° C. for 10 minutes. After that, it was fully dried at 165° C. for 60 minutes to form second solid electrolyte layer 3b. Further, carbon layer 4a and silver electroconductive resin layer 4b were formed to produce a capacitor element.

### Example 2

An electroconductive polymer solution was obtained in the same manner as in Example 1 except that 0.43 g of EPOCROS (registered trademark) WS-500 (39 wt % aqueous solution, produced by NIPPON SHOKUBAI CO., LTD.) as the oxazoline group-containing compound and 0.16 g of phthalic acid as the water-soluble compound were used, and a capacitor element was produced.

### Example 3

An electroconductive polymer solution was obtained in the same manner as in Example 1 except that 0.61 g of EPOCROS (registered trademark) K-2020E (40 wt % aqueous emulsion, produced by NIPPON SHOKUBAI CO LTD.) as the oxazoline group-containing compound and 0.09 g of phthalic acid as the water-soluble compound were used, and a capacitor element was produced.

### Example 4

An electroconductive polymer solution was obtained in the same manner as in Example 3 except that 0.61 g of EPOCROS (registered trademark) K-2030E (40 wt % aqueous emulsion, produced by NIPPON SHOKUBAI CO., LTD.) as the oxazoline group-containing compound was used, and a capacitor element was produced.

### Example 5

An electroconductive polymer solution was obtained in the same manner as in Example 3 except that 0.61 g of EPOCROS (registered trademark) K-2010E (40 wt % aqueous emulsion, produced by NIPPON SHOKUBAI CO., LTD.) as the oxazoline group-containing compound was used, and a capacitor element was produced.

### Example 6

An electroconductive polymer solution was obtained in the same manner as in Example 1 except that 0.40 g of EPOCROS (registered trademark) WS-700 (25 wt % aqueous solution, produced by NIPPON SHOKUBAI CO., LTD.) as the oxazoline group-containing compound and 0.45 g of 4-sulfo phthalate (50 wt % aqueous solution) as the water-soluble compound were used, and a capacitor element was produced.

### Example 7

An electroconductive polymer solution was obtained in the same manner as in Example 6 except that 0.32 g of p-phenol sulfonic acid as the water-soluble compound was used, and a capacitor element was produced.

### Example 8

An electroconductive polymer solution was obtained in the same manner as in Example 6 except that 0.03 g of salicylic acid and 0.10 g of phthalic acid as the water-soluble compound was used, and a capacitor element was produced.

### Example 9

An electroconductive polymer solution was obtained in the same manner as in Example 1 except that 0.03 g of EPOCROS (registered trademark) WS-700 (25 wt % aqueous solution, produced by NIPPON SHOKUBAI CO., LTD.) as the oxazoline group-containing compound and 0.22 g of PESRESIN A645GH (30 wt % aqueous solution) as the water-soluble compound were used, and a capacitor element was produced.

### Example 10

An electroconductive polymer solution was obtained in the same manner as in Example 9 except that 0.27 g of PESRESIN A684G (25 wt % aqueous solution) as the water-soluble compound was used, and a capacitor element was produced.

### Example 11

An electroconductive polymer solution was obtained in the same manner as in Example 1 except that 0.04 g of EPOCROS (registered trademark) WS-700 (25 wt % aqueous solution, produced by NIPPON SHOKUBAI CO., LTD.) as the oxazoline group-containing compound and 0.39 g of a polyacrylic acid (25 wt % aqueous solution, molecular weight: 15×10⁴) as the water-soluble compound were used, and a capacitor element was produced.

### Comparative Example 1

An electroconductive polymer solution was obtained in the same manner as in Example 1 except that the oxazoline group-containing compound and the water-soluble compound were not mixed, and a capacitor element was produced.

### Example 12

An electroconductive polymer solution was obtained in the same manner as in Example 1 except that 0.40 g of EPOCROS (registered trademark) WS-700 (25 wt % aqueous solution, produced by NIPPON SHOKUBAI CO LTD.) as the oxazoline group-containing compound, 0.39 g of a polyacrylic acid (25 wt % aqueous solution, molecular weight: 15×10⁴) as the water-soluble compound and 0.89 g of a polyvinyl alcohol (average polymerization degree: 1500) were used, and a capacitor element was produced.

### (Evaluation of Capacitor Element)

The initial ESRs of these capacitor elements at 100 kHz were measured. After that, as the evaluation of the heat resistance property, the capacitor elements were left under an atmosphere at 125° C. with no load for 500 hours, and the ESRs at 100 kHz were then measured again. The ESR changing ratio (=ESR after leaving/ESR before leaving) was calculated. The evaluation numbers were each set to be 10. The evaluation results (average) are shown in TABLE 1.

TABLE 1

| | Initial ESR (mΩ) | ESR changing ratio |
|---|---|---|
| Example 1 | 7.7 | 1.8 |
| Example 2 | 7.8 | 1.7 |
| Example 3 | 8.3 | 1.9 |
| Example 4 | 8.2 | 2.0 |
| Example 5 | 8.2 | 2.1 |
| Example 6 | 8.4 | 1.9 |
| Example 7 | 8.1 | 1.9 |
| Example 8 | 8.1 | 2.1 |
| Example 9 | 8.1 | 2.0 |
| Example 10 | 7.9 | 1.7 |
| Example 11 | 8.0 | 1.9 |
| Comparative | 8.1 | 4.6 |
| example 1 | | |
| Example 12 | 15.4 | 2.3 |

It has been found that the effect of the present invention can be obtained by using, as solid electrolyte, an electroconductive polymer composition which contains an oxazoline group-containing compound and a water-soluble compound in an electroconductive polymer solution and which has an optimum composition.

### Example 13

The electroconductive polymer solution used in Example 1 was dropped on a glass slide and was preliminarily dried at 120° C. for 5 minutes. After that, it was dried at 165° C. for 60 minutes to obtain an electroconductive polymer composition.

### Example 14

The electroconductive polymer solution used in Example 4 was dropped on a glass slide and was preliminarily dried at 120° C. for 5 minutes. After that, it was dried at 165° C. for 60 minutes to obtain an electroconductive polymer composition.

### Example 15

The electroconductive polymer solution used in Example 9 was dropped on a glass slide and was preliminarily dried at 120° C. for 5 minutes. After that, it was dried at 165° C. for 60 minutes to obtain an electroconductive polymer composition.

### Comparative Example 3

The electroconductive polymer solution used in Comparative Example 1 was dropped on a glass slide and was preliminarily dried at 120° C. for 5 minutes. After that, it was dried at 165° C. for 60 minutes to obtain an electroconductive polymer composition.

### Example 16

The electroconductive polymer solution used in Example 12 was dropped on a glass slide and was preliminarily dried at 120° C. for 5 minutes. After that, it was dried at 165° C. for 60 minutes to obtain an electroconductive polymer composition.

The surface resistances (Ω/□) of these electroconductive compositions were measured. After that, as a heat resistance property, the electroconductive compositions were left under an atmosphere at 125° C. with no load for 500 hours. The surface resistance changing ratio (=surface resistance value after leaving/surface resistance value before leaving) was calculated. The surface resistance value was measured using Loresta (registered trademark)-GPMCP-610 (Mitsubishi Chemical Analytech Co., Ltd.). The evaluation numbers were each set to be 3. The evaluation results (average) are shown in TABLE 2.

TABLE 2

| | Initial surface | Surface resistance |
|---|---|---|
| | resistance (Ω/□) | changing ratio |
| Example 13 | 263 | 1.5 |
| Example 14 | 280 | 1.6 |
| Example 15 | 267 | 1.7 |
| Comparative | 274 | 4.3 |
| example 3 | | |
| Example 16 | 1064 | 2.1 |

From TABLE 2, it has been found that the electroconductive polymer composition of the present invention has a low resistance and an excellent heat resistance. Note that, these results correlate with the results of the initial ESR and the heat resistance property of the capacitor shown in TABLE 1.

It has become clear that the electroconductive polymer composition obtained by removing the solvent or the dispersing medium from the electroconductive polymer solution of the present invention has a low resistance and a high strength, and can thereby provide an electroconductive polymer composition in which the deterioration of the electroconductivity by a heat stress or the like is suppressed and which has a high heat resistance. Also, due to these, it has become clear that the capacitor containing the electroconductive polymer composition as a solid electrolyte has a low ESR and an excellent heat resistance.

The present invention is utilized for electrodes and solid electrolytic capacitors of electronic devices such as solar cells, organic electroluminescence displays and touch panels.

What is claimed is:

1. An electroconductive polymer solution, comprising:
an electroconductive polymer in which a dopant is doped;
an oxazoline group-containing compound;
a water-soluble compound having at least one of carboxyl group, aromatic phenol group and thiol group as a functional group; and
a solvent or a dispersing medium.

2. The electroconductive polymer solution according to claim 1, comprising the oxazoline group-containing compound and the water-soluble compound in a range of 1.0:0.2 to 1.3 in a mol ratio of the corresponding functional group.

3. The electroconductive polymer solution according to claim 1, wherein the electroconductive polymer comprises at least one kind selected from the group consisting of polypyrroles, polythiophenes and polyanilines, and derivatives thereof.

4. The electroconductive polymer solution according to claim 1, wherein the electroconductive polymer comprises a repeating unit of 3,4-ethylenedioxythiophene or a derivative thereof.

5. An electroconductive polymer composition, which is obtained by removing the solvent or the dispersing medium from the electroconductive polymer solution according to claim 1, and which comprises an amide ester unit formed from the electroconductive polymer, the oxazoline group-containing compound and the water-soluble compound.

6. An electroconductive polymer composition, obtained by heating the electroconductive polymer solution according to claim 1 at 80° C. or higher and 300° C. or lower to remove the solvent or the dispersing medium.

7. A solid electrolytic capacitor comprising a solid electrolyte which comprises the electroconductive polymer composition according to claim 5.

8. A method for producing a solid electrolytic capacitor, comprising:
forming a dielectric layer on a surface of an anode conductor comprising a valve metal;
carrying out an application or an impregnation of the electroconductive polymer solution according to claim 1 on the dielectric layer; and
removing the solvent or the dispersing medium from the electroconductive polymer solution to form a solid electrolyte layer comprising the electroconductive polymer composition.

9. A method for producing a solid electrolytic capacitor, comprising:
forming a dielectric layer on a surface of an anode conductor comprising a valve metal;
carrying out an oxidative polymerization of a monomer providing an electroconductive polymer on the dielectric layer to form a first solid electrolyte layer containing the electroconductive polymer;
carrying out an application or an impregnation of the electroconductive polymer solution according to claim 1 on the first solid electrolyte layer; and
removing the solvent or the dispersing medium from the electroconductive polymer solution to form a second solid electrolyte layer.

10. An electroconductive polymer composition, wherein an amide ester unit is formed from an oxazoline group-containing compound and a water-soluble compound having at least one of carboxyl group, aromatic phenol group and thiol group as a functional group, and wherein the unit is laid in an electroconductive polymer matrix or between electroconductive polymer dispersing particles.
